(19) United States
(12) Patent Application Publication
(10) Pub. No.: US 2018/0357619 A1
(43) Pub. Date: Dec. 13, 2018

(54) Supplier Finance and Invoice Presentation and Payment

(71) Applicant: Wells Fargo Bank, N.A., San Francisco, CA (US)

(72) Inventors: Armand J. Brunelle, III, Attleboro, MA (US); Erik Wanberg, Mill Valley, CA (US)

(21) Appl. No.: 14/579,060

(22) Filed: Dec. 22, 2014

(51) Int. Cl. G06Q 20/10

(52) U.S. Cl. CPC G06Q 20/102

(57) ABSTRACT

A method implemented for processing invoices includes receiving invoice data for one or more invoices. The invoice data is received from a supplier and directed to a buyer. An approval for one or more invoices based on the invoice data is received. A request is received for payment for a dollar amount on a specific date. An optimized set of unpaid vouchers for the supplier is automatically determined. The set of unpaid vouchers is based on the one or more invoices and any other invoices for which payment is due to the supplier. A net value of all or part of the set of unpaid vouchers is equal to or greater than the dollar amount. The net value results in a minimum discount cost associated with the unpaid vouchers. A payment is initiated for all or part of the optimized set of unpaid vouchers for the supplier.

### BACKGROUND

Suppliers of business products may sell their products to a plurality of buyers, typically other businesses. Similarly, businesses may buy products from a plurality of suppliers. Some suppliers may be small in size and may send the buyers hand-generated invoices or invoices that are not compatible with the buyer's computer systems. Converting the invoices into a format compatible with the buyer's computer systems may result in errors and can add cost and complexity to the processing and payment of those invoices.

Businesses that buy products from suppliers may also have different payment terms. Suppliers may expect payment within a short period of time, for example, 30 days from a sale, but some large businesses have the buying power to stretch payments out to, for example, 90 days. Sometimes a supplier wants to be paid sooner than a buyer is willing to pay. One reason early payment may be desired is to maintain cash flow for the supplier. It can be financially difficult, particularly for smaller suppliers, to determine how to most efficiently accomplish early payment terms.

### SUMMARY

Embodiments of the disclosure are directed to a method implemented on a first electronic computing device for processing invoices. The method comprises: on the first electronic computing device, receiving from a second electronic computing device first invoice data for one or more first invoices, the first invoice data being received from a first supplier and being directed to a first buyer; receiving an approval for one or more first invoices from a third electronic computing device, the one or more first invoices being based on the first invoice data, the third electronic computing device being associated with the first buyer; receiving a request from the second electronic computing device for payment for a first dollar amount on a specific date; automatically determining, by the first electronic computing device, an optimized set of unpaid vouchers for the first supplier, the set of unpaid vouchers being based on the one or more first invoices and any other invoices for which payment is due to the first supplier, a net value of all or part of the set of unpaid vouchers being equal to or greater than the first dollar amount, the net value resulting in a minimum discount cost associated with the unpaid vouchers; and initiating a payment for all or part of the optimized set of unpaid vouchers for the first supplier.

In another aspect, a first electronic computing device for processing invoices comprises: a processing unit; and system memory, the system memory including instructions which, when executed by the processing unit, cause the first electronic computing device to implement: an invoice data processing module that receives and processes invoice data from a second electronic computing device, the invoice data being comprised of sales data for one or more products that are sold from a first supplier associated with the second electronic device to a first buyer associated with a third electronic computing device; an invoice approval module that permits review by the first buyer of the invoice data and that permits approval of payment for one or more first invoices by the first buyer, the first invoices corresponding to the invoice data; a payment module that initiates payment of one or more of the first invoices based on the approval of the first buyer; and a discounting module that determines a minimum discount cost for a set of second invoices initiated from the first supplier to generate a cash payment amount for the first supplier, the set of second invoices including all or part of the first invoices, the cash payment amount to be paid to the first supplier at a specified date, the specified date being earlier than a payment due date for each invoice in the set of second invoices.

In yet another aspect, a first electronic computing device comprises: a processing unit; and system memory, the system memory including instructions which, when executed by the processing unit, cause the first electronic device to: receive from a second electronic computing device first invoice data for one or more first invoices, the first invoice data being received from a first supplier and being directed to a first buyer; receive an approval for one or more first invoices from a third electronic computing device, the one or more first invoices being based on the first invoice data, the third electronic computing device being associated with the first buyer; receive a request from the second electronic computing device for payment for a first dollar amount on a specific date; automatically determine an optimized set of unpaid vouchers for the first supplier, the set of unpaid vouchers being based on the one or more first invoices and any other invoices for which payment is due to the first supplier, a net value of all or part of the set of unpaid vouchers being equal to or greater than the first dollar amount, the net value resulting in a minimum discount cost associated with the unpaid vouchers; and initiate a payment for all or part of the optimized set of unpaid vouchers for the first supplier.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system that supports integrating supplier financing with an enterprise invoice and payment system.

FIG. 2 shows example modules of the financial institution server computer of FIG. 1.

FIG. 3 shows an example user interface screen for a selective payment workbench.

FIG. 4 shows another example user interface screen for a selective payment workbench.

FIG. 5 shows a table with example discount percentages for an example buyer.

FIG. 6 shows a flowchart for an example method implemented on the financial institution server computer of FIG. 1 for paying an invoice.

FIG. 7 shows a flowchart for another example method implemented on the financial institution server computer of FIG. 1 for paying an invoice.

FIG. 8 shows a flowchart for an example method for selecting invoices for early payment from the selective payment workbench.

FIG. 9 shows a flowchart for an example method for alerting a supplier of early payment scenarios.

FIG. 10 shows example physical components of the financial institution server computer of FIG. 1.

### DETAILED DESCRIPTION

The present disclosure is directed to systems and methods for integrating supplier financing with an enterprise invoice and payment system for a business. Using the systems and methods, an integrated system can be used to both automate an invoice generation process for business suppliers and to automate a selection and discount process for early payment of invoices to the suppliers.

In the examples provided herein, a supplier provides goods or services to a buyer. One example is a painting company (supplier) paints a store owned by a retailer (buyer). When such a service or good is provided, the supplier sends an invoice to the buyer. The buyer pays the amount on that invoice to the supplier at a later point in time, as described further below.

Many small business suppliers do not have electronic invoice generating capability. As a result, small suppliers sometimes fax an invoice to a buyer or send a paper invoice. When the buyer is a large business, for example a Wal-Mart, the business typically has a staff of personnel to enter the invoice data into an electronic invoice system. Using the systems and methods described herein, the supplier can access a server computer, for example a server computer from a financial institution such as a bank, and upload or enter the invoice data directly into the server computer. In some embodiments, the server computer can include software that converts the invoice data into a format that is compatible with the electronic invoice system used by the large business. In other embodiments, the server computer can provide a form in which the suppliers can enter the invoice data. The invoice data can then be sent electronically to the business.

In addition, the systems and methods described herein can obviate the need for the buyers to download supplier invoices into the buyers' electronic invoice system. Instead, buyers can review, approve and pay invoices from suppliers via the server computer from the financial institution. Entering supplier invoice data electronically can improve efficiency, reduce errors for both suppliers and buyers, reduce or eliminate transcription expenses for suppliers and expedite cash receipt for suppliers.

In another aspect of the systems and methods described herein, supply chain finance programs offered by financial institutions can be enhanced. Some very large retailers, for example Wal-mart, Staples, CVS Pharmacy, etc. make use of supply chain finance programs. Many of these large retailers want to extend a payment cycle. For example, instead of paying suppliers 30 days after a purchase, they may want to pay in 90 days. Extending the payment cycle in this manner may be unacceptable to many suppliers, particularly small suppliers.

To remedy this situation, retailers sometimes enter into a supplier chain finance program with a financial institution such as a bank. The bank may agree to pay the supplier earlier, for example within 30 days after the purchase, but may charge the supplier a discount to get paid earlier. For example, the bank may charge a 3% discount to the supplier to get paid within 30 days after the purchase, so that if the amount of the purchase is $1,000, the supplier will get paid $970 instead of $1,000. Suppliers may accept this arrangement because although they are paying a discount, they are also getting paid sooner, thereby improving the supplier's cash flow and reducing the days sales outstanding (DSO) time.

In addition, the amount of the discount is generally based on the credit rating of the buyer, for example the large retailer, rather than the credit rating of the supplier. Credit ratings of large retailers are usually higher than credit ratings for small suppliers, so the discount that the supplier pays is generally lower than if the supplier's credit rating were used. In addition, some large buyers have higher credit ratings than others, so the discount the supplier pays may vary based on the credit rating of the buyer that purchased the supplier's product.

Many suppliers commonly have multiple outstanding invoices, often with multiple buyers. When a supplier requires early payment, for example to improve supplier cash flow, the supplier may need to choose among different invoices from different buyers, with different invoice amounts, due dates and discount rates. Using the systems and methods, the selection process can be automated for invoices to be paid early. The systems and methods include a selective payment workbench, to be explained in more detail later herein. Using the selective payment workbench, a supplier can select a specific dollar amount of invoices to be paid at a certain date. The invoices can be from multiple buyers. The systems and methods can determine an optimal selection of invoices that will provide the specific dollar amount the supplier requires at the specific date the supplier requires and at an optimized lowest discount cost for the supplier.

The systems and methods can also provide a report that proactively alerts suppliers that they can get paid early. For example, the report may indicate that a supplier has a certain amount of outstanding invoices, for example $5 million dollars of invoices, and that the supplier can be paid a certain amount soon, for example $1 million dollars in two days, for a discount of a specified dollar amount, for example $25,000. After being made aware of this information, the supplier may decide to accept the offer. Because the discount gets paid to the financial institution, for example the bank, the bank makes money whenever the supplier accepts a discount.

In the examples described herein, the automation for the invoice generation process and for the selection and discount process for early payment of invoices is accomplished using computing devices that have been programmed to perform special, complex functions. These specially-programmed devices function to manipulate and provide data to the users in an improved form factor and with greater efficiency.

For example, as described in more detail below, the processes performed by the computing devices allows the user to more effectively and efficiently generate invoices for business suppliers and select invoices for early payment to suppliers. Such processes can be accomplished using logic and interfaces that are more intuitive and robust for the user.

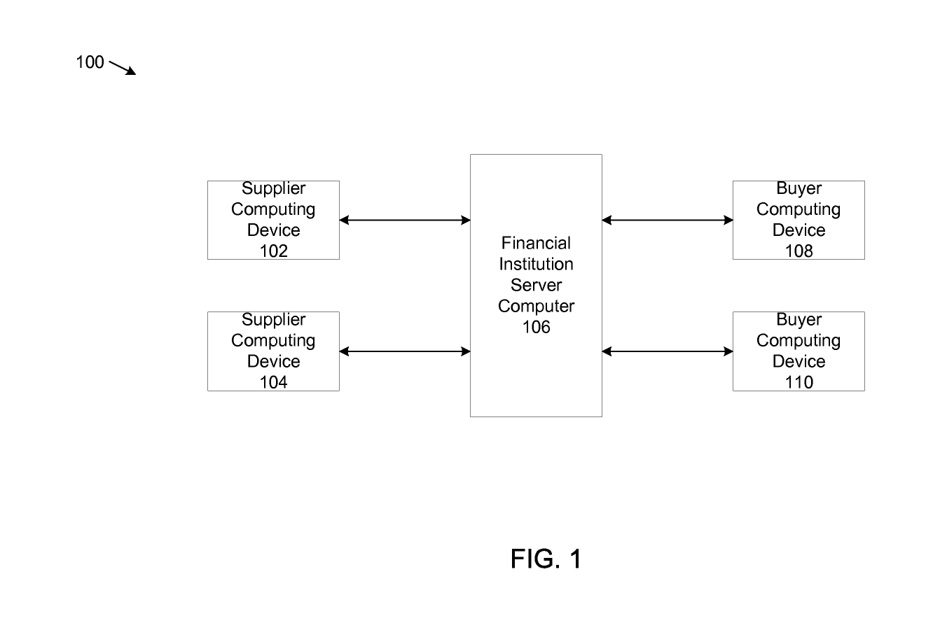

FIG. 1 shows an example system 100 that supports integrating supplier financing with an enterprise invoice and payment system for a business. The example system 100 includes supplier computing devices 102, 104, a financial institution server computer 106 and buyer computing devices 108, 110. More or fewer supplier computing devices and buyer computing devices may be used.

The supplier computing devices 102, 104 are computing devices for suppliers of products and/or services. The supplier computing devices 102, 104 may be client computers, laptop computers, desktop computers, mobile devices such as smartphones or any similar electronic computing devices. In system 100, supplier computing device 102 represents a computing device for one supplier and supplier computing device 104 represents a computing device for a second supplier. However each of the first supplier and second supplier typically has more than one computing device. In addition, system 100 can include computing devices (not shown) from additional suppliers.

The buyer computing devices 108, 110 are computing devices for buyers of the business products sold by suppliers, including the first supplier, the second supplier and any additional supplier in system 100. The buyers are businesses that use the products sold by the suppliers. The buyer computing devices may be server computers, client computers, laptop computers, desktop computers, mobile devices or any similar electronic computing devices. In system 100, buyer computing device 108 represents a computing device for one business, typically a retailer, and buyer computing device 110 represents a computing device for a second business. However each of the first buyer and second buyer typically has more than one computing device. In addition, system 100 can include computing devices (not shown) from additional buyers.

The financial institution server computer 106 is a server computer at a financial institution, herein referred to as a bank. The bank is one that provides a third party supplier finance service to the suppliers and the buyers. The bank makes money by providing an early payment service to suppliers. The discount that the suppliers pay is paid to the bank and constitutes income for the bank. The bank can also make additional money by receiving suppliers invoicing data and providing electronic invoices to the buyers. The buyers may pay a fee to the bank for this service. The financial institution server computer 106 may provide electronic forms in which suppliers enter invoice data. Alternatively, or in addition to the electronic forms the financial institution server computer 106 can include software that converts invoice data from the suppliers into a format compatible with a corresponding buyer computing device. In some embodiments, the financial institution server computer 106 sends electronic records of invoices to the corresponding buyer computing device. In other embodiments, the financial institution server computer 106 permits both suppliers and buyers to view and enter data into electronic forms, permitting online invoice approval and payment.

Using the systems and methods of system 100, a product supplier on supplier computing device 102 or on supplier computing device 104 can submit invoice data to financial institution server computer 106. The invoice data can be submitted into formatted invoice forms on server computer 106. In some implementations, the formatted invoice data can be sent to an associated buyer computing device 108 or buyer computing device 110. In other implementations, authorized personnel at buyer computing device 108 or buyer computing device 110 can review the invoice data on server computer 106, approve the invoice and initiate payment of the invoice.

In addition, suppliers on supplier computing device 102 or supplier computing device 104 can logon to the selective payment workbench and determine a discount rate for early payment of invoices. The selective payment workbench is discussed in more detail later herein.

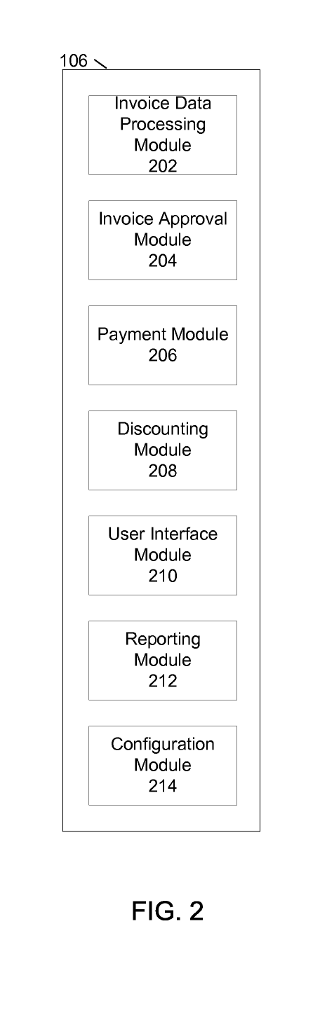

FIG. 2 shows example modules of financial institution server computer 106. The example modules include an invoice data processing module 202, an invoice approval module 204, a payment module 206, a discounting module 208, a user interface module 210, a reporting module 212 and a configuration module 214.

The example invoice data processing module 202 provides functionality to permit suppliers to upload or enter invoice data into the financial institution server computer 106. Suppliers can be given login accounts on the financial institution server computer 106. Once logged in, a supplier can either upload the invoice data or access an electronic invoice form on which the supplier can enter the invoice data. The invoice data can then be sent electronically to a buyer. In some implementations, the invoice data processing module 202 can generate a generic invoice from the invoice data and send the generic invoice to the buyer. In other implementations, the invoice data processing module 202 may generate an invoice in a format specified by a specific buyer. The invoice data processing module 202 may also permit a buyer to view the invoice data online.

The example invoice approval module 204 processes an invoice approval from the buyer and also permits the buyer to approve the invoice online, for example by reviewing the invoice form from the supplier online. When an invoice is approved, the invoice approval module 204 sends an electronic confirmation of the invoice approval to buyer computing device 108 or to buyer computing device 110 and also creates an internal record of the invoice approval and an internal voucher for the supplier.

The example payment module 206 processes invoice payments for the supplier. In an example implementation, the supplier can access a selective payment workbench implemented on financial institution server computer 106 and select specific invoices for payment. Alternately, the financial institution server computer 106 can automatically select invoices for payment that will minimize discounting costs for the supplier. Discounting is discussed in more detail later herein.

When invoices are selected for payment, the payment module 206 generates a payment and sends the payment to the supplier. In addition, the payment module 206 notifies the buyer that a payment for specific invoice amounts has been made to the supplier. When a payment remittance for the specific invoice amounts is received from the buyer, the payment module 206 generates an internal cash receipt and settles the invoice transaction. Depending on the invoices selected for payment by the supplier, the payment module may receive payment remittances from more than one buyer.

The example discounting module 208 calculates discounts for early payment of invoices. Discounts are based on the amount of time between when a supplier requires payment on an invoice and when the invoice is due. Discounts are also based on the credit rating of the buyer. The discounting module 208 also automatically determines a minimum discount that can be applied to selected invoices in order to provide payment to the supplier of a specific dollar amount at a specific time. The discounting module 208 operates in conjunction with the selective payment workbench, as discussed later herein.

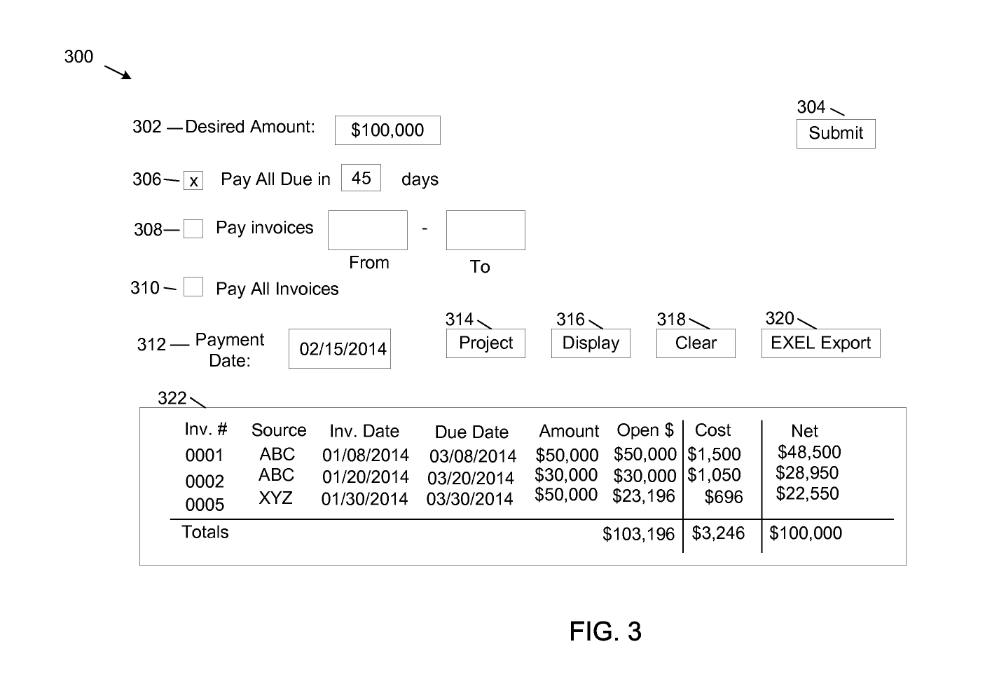

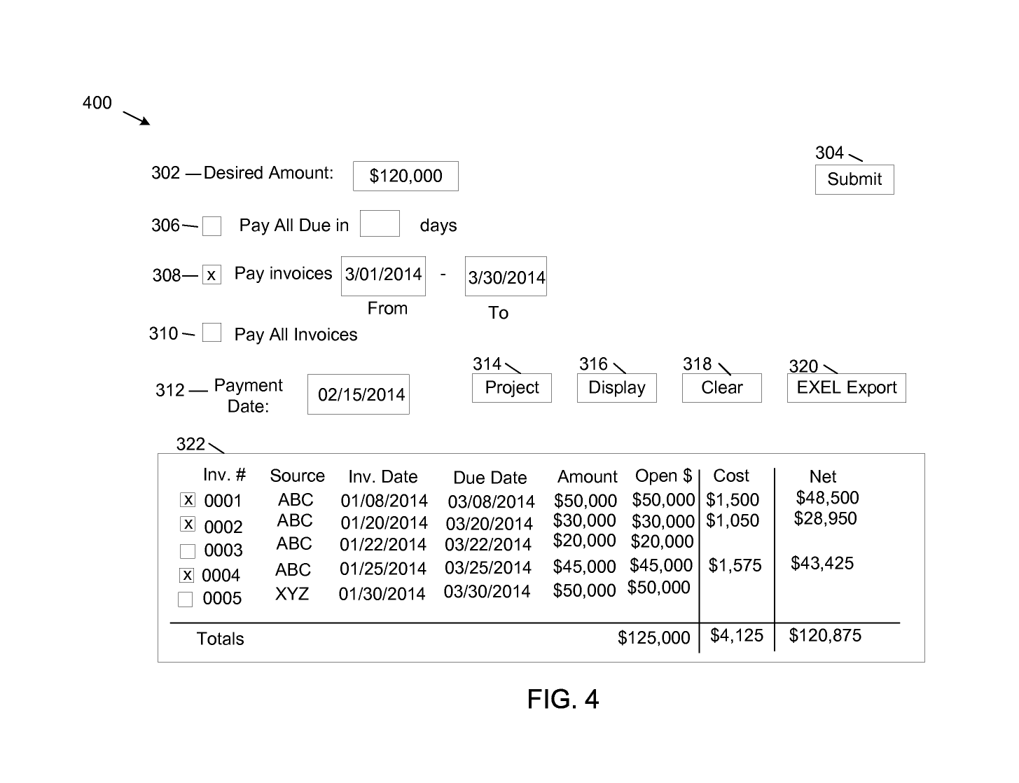

The user interface module 210 renders the selective payment workbench to the user. The selective payment workbench is discussed in more detail in conjunction with FIGS. 3 and 4, as described later herein.

The example reporting module 212 provides alerts to suppliers regarding early payment of invoices. The reporting module 212 periodically evaluates supplier's outstanding invoices and determines when early payment offers may be made to suppliers. For example, if a supplier has $1 million in outstanding invoices, the reporting module 212 may determine a discount cost for payment on a percent of the $1 million on a certain date. The reporting module 212 can then proactively send an alert to the supplier with an offer. As an example offer may be for payment of $250,000 by Friday for a cost of $7,500. After reviewing the offer, the supplier may determine that a cost of $7,500 is a reasonable amount to pay to receive the $250,000 and improve the supplier's cash flow.

The reporting module 212 can also generate reporting and analytics to the supplier. The reporting and analytics can provide a summary and analysis of the supplier's outstanding invoices and also provide suggestions for early payment of all or part of the outstanding invoices.

The example configuration module 214 configures certain aspects of supplier and buyer relationships. One aspect can involve determining discount rates for early payment of invoices. As stated earlier and as discussed in more detail later herein, discount rates are determined based on a time between when payment is needed for an invoice and the time that the invoice is due. Discount rates are also determined based on the credit rating of the buyer. Using the discount rate of the buyer usually permits the supplier to obtain a lower discount rate than if the supplier's credit rating was used. The configuration module 214 indicates which discount rate schedule is applied to a specific supplier/buyer relationship.

Other aspects that may be configured include a percentage of outstanding invoices that may be proactively offered to a supplier for early payment. For example, when a supplier has $1 million in outstanding invoices, 25% or $250,000 may be offered for early payment. As another example, when a supplier has between $5 million and $10 million in outstanding invoices only 15% of the total may be proactively offered for early payment. The percentage may be configured on a per supplier basis.

FIG. 3 shows an example user interface screen 300 for a selective payment workbench. The example selective payment workbench can be rendered on supplier computing device 102, 104 when the supplier logs onto the financial institution server computer 106. The selective payment workbench permits suppliers to select one or more invoices for early payment and also permits automatic selection of invoices to minimize a discount cost for early payment.

The selective payment workbench shown in FIG. 3 includes a field 302 for entering a dollar amount for early payment. For the example user interface screen 300, an amount of $100,000 is entered. A field 312 is included for entering an early payment date. For the example user interface screen 300, a payment date of Feb. 15, 2014 is entered.

The example selective payment workbench also gives the provider options regarding which invoices to select for early payment. Checkbox 306 permits the supplier to select paying all invoices that are due within a specific number of days from the present, checkbox 308 permits the user to select a range of invoices from a starting date to an ending date and checkbox 310 permits the user to select all outstanding invoices.

For the example shown in FIG. 3, checkbox 306 is checked and a total of 45 days are entered. When the Project button 314 is selected, the discounting module 208 automatically determines an optimized selection of invoices due within 45 days such that net proceeds of $100,000 are obtained from the invoices selected at a minimal discount cost to the supplier. The results of the optimization are displayed in summary area 322.

Summary area 322 includes columns for invoice number, invoice date due date, amount, open dollars, cost and net. As shown, invoices 0001, 0002 and 0005 are selected for early payment. Invoices 0001 and 0002 are from buyer ABC and invoice 0005 is from buyer XYZ. As shown in summary area 322, invoice 0001 is for $50,000, invoice 0002 is for $30,000 and invoice 0005 is for $50,000. Based on a credit rating for ABC, because the due date Mar. 8, 2014 for invoice 0001 is 21 days from the payment date of Feb. 15, 2014, a discount rate of 3% is used for the $50,000 amount for invoice 0001, generating a cost of $1,500 and a net amount of $48,500. Similarly, because the due date Mar. 20, 2014 for invoice 0002 is 39 days from the payment date of Feb. 15, 2014, a discount rate of 3.5% is used for the $30,000 amount for invoice 0002, generating a cost of $1,050 and a net amount of $28,950.

Invoice 0005 is for an amount of $50,000. However, when the net amounts of $48,500 and $28,950 are deducted from $100,000 only $22,500 is needed to reach a total of $100,000. Therefore, only part of the $50,000 for invoice 0005 needs to be paid. In addition, because, for this example, buyer XYZ is a larger company than buyer ABC, buyer XYZ has a higher credit rating than buyer ABC. For invoice 0005 having a due date that is 43 days from the payment date of Feb. 15, 2014, a discount rate of 4% would be used with the credit rating for company ABC. However, because buyer XYZ has a higher credit rating than buyer ABC, a discount rate of 3% is used instead for invoice 0005. The lower discount rate results in a lower discount cost to the supplier than if an additional invoice from buyer ABC were used for payment. This is one example of how the optimization using the system and methods reduced the overall discount cost to the supplier.

To derive $22,500 at a discount rate of 3%, $23,196 needs to be paid from the $50,000 amount for invoice 0005. This results in a net cost of $696 for invoice 0005 ($23,737 multiplied by 3%). The total discount cost for the three invoices is $3,246. Thus, to obtain $100,000 on Feb. 15, 2014, the buyer would need to pay $3,246. A more detailed explanation of how the discount rates are chosen for the three invoices in the example is provided later herein.

When the supplier accepts the projected optimization shown in the summary area 322, the supplier can select Submit button 304 to initiate a payment process. The supplier can also select EXCEL input button 320 to export data in the summary area 322 to an EXCEL spreadsheet.

If the supplier does not accept the projected optimization, the supplier can select the Clear button 318 to clear the display. The supplier can then select alternate options 306, 308 and 310 and specifying different parameters for these options. The supplier can then select the Project button 314 to initiate and project a new optimization for the summary area 322. Alternatively, the supplier can manually select invoices for payment as discussed next with regard to FIG. 4.

FIG. 4 shows another user interface screen shot 400 for the selective payment workbench. For the user interface screen shot 400, the desired amount 302 for early invoice payment is $120,000. In addition, the pay invoices 308 checkbox is selected specifying selection invoices with due dates from Mar. 1, 2014 through Mar. 30, 2014. The desired payment date 312 is still Feb. 15, 2014.

The user interface screen shot 400 shows an example screen shot of a manual invoice selection process. When the Display 316 button is selected, a summary of all outstanding invoices with due dates from Mar. 1, 2014 through Mar. 30, 2014 are displayed in the summary area 322. If more invoice data is available than can be displayed on one screen, the invoice data is displayed on multiple screens. Forward and reverse arrows (not shown in FIG. 4) can be used to navigate between the multiple screens.

A checkbox is displayed to the left of each line in summary area 322 on which invoice information is displayed. When a checkbox is selected, a cost and net value are displayed for the invoice that is selected. The cost and net value are also reflected in Totals information at the bottom of summary area 322.

The example summary area 322 shows that three invoices are selected—invoice numbers 0001, 0002 and 0004, in this example all from buyer ABC. Based on the number of days between the desired payment date of Feb. 15, 2014 and the due date, a discount of 3% is applied to invoice 0001, and discounts of 3.5% are applied to each of invoices 0002 and 0004. The result is that $125,000 of invoices is selected at an early payment cost to the supplier of $4,125, resulting in a net amount to the supplier of $120,875. If the supplier approves, the buyer can select the Submit button 304 to initiate payment on these three invoices. If the supplier does not approve, the supplier can check or uncheck any invoice box to determine a different combination. The supplier can also select a partial payment of an invoice by entering a dollar amount in the Open $ column. The discount cost is based on the dollar amount in the Open $ column.

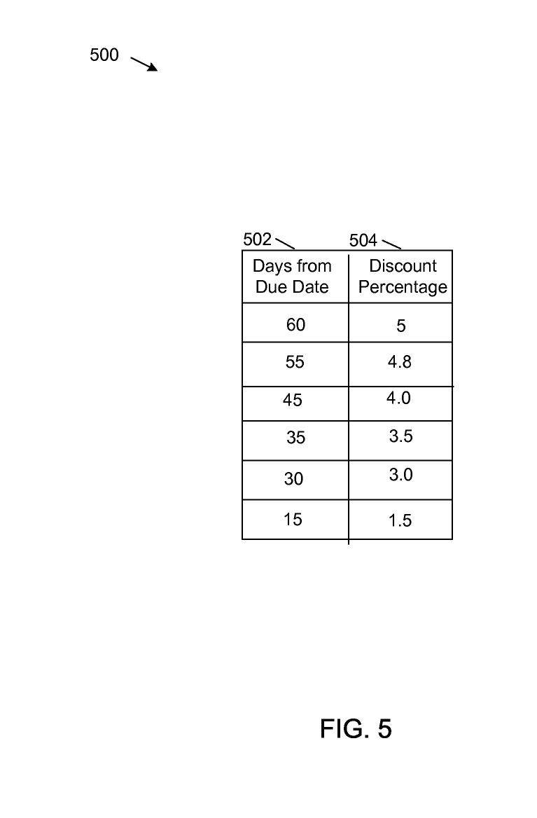

FIG. 5 shows an example table 500 showing example discount percentages used for a particular buyer, in this case buyer ABC, based on the number of days from the due date of an invoice that payment is required. The table 500 has a column 502 for days from due date and a corresponding column 504 for the corresponding discount percentage that is used. As shown in table 500, the greater the number of days the due date of an invoice is from the desired payment date, the higher the discount percentage. So for example, when an invoice due date is 60 days from the desired payment date, a discount percentage of 5% is used. Similarly, when the invoice due date is 45 days from the desired payment date, a discount percentage of 4% is used.

As discussed earlier herein, the discount percentage is based on the credit rating of the buyer. The discount percentages shown in table 500 are all for example buyer ABC. The discount percentages may be higher or lower than shown in table 500 when the credit rating of a buyer is lower or higher, respectively than the credit rating of buyer ABC. The lower the credit rating, the higher the discount percentage. For example, as indicated earlier herein, with respect to buyer XYZ, the percentage for an invoice due 45 days from the desired payment date is 5% instead of the 4% shown for buyer ABC.

The percentages shown in table 500 are only examples. Higher of lower discount percentages may be used. In addition, for the example of table 500, a discount cost is only applied if the invoice to be paid early is at least 15 days from the due date. In other implementation, the discount cost may be applied earlier or later than the due date.

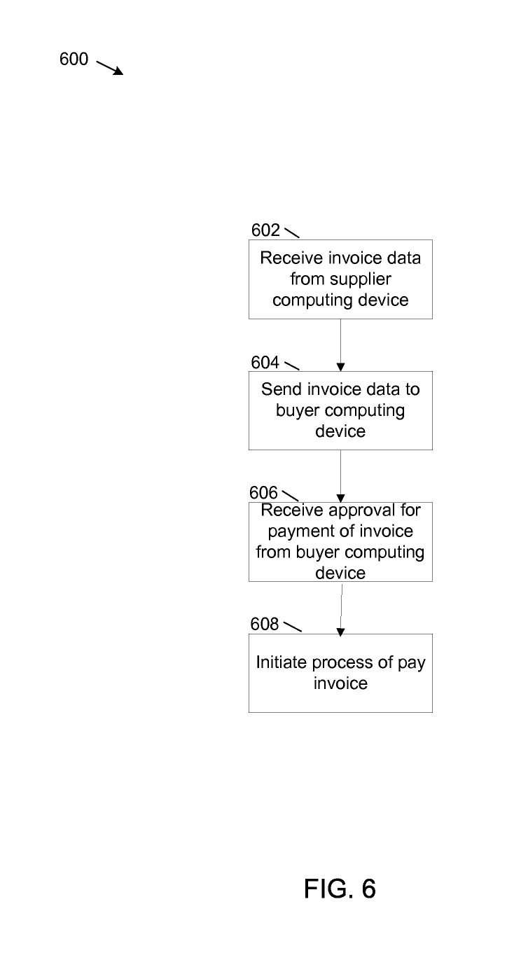

FIG. 6 shows a flowchart of an example method 600 for a process of paying an invoice. The invoice is created from invoice data from a supplier and is directed to a buyer who purchased one or more products listed on the invoice from the supplier. The invoice is processed at a third party financial institution computing device, in this example at financial institution server computer 106. The third party financial institution computing device provides a service to both the supplier and to the buyer, providing functionality of an invoice processing system to the supplier and providing electronic invoice data to a buyer from suppliers than may not have electronic invoice data processing capability.

At operation 602, invoice data from the supplier at a supplier computing device is received at financial institution server computer 106. Some suppliers may prefer to upload invoice data to the financial institution server computer 106. Other suppliers may prefer to enter the invoice data electronically into a form on the financial institution server computer 106.

At operation 604, the invoice data is sent from the financial institution server computer 106 to a buyer computing device such as buyer computing device 108 or buyer computing device 110. In some implementations, when an electronic text document or spreadsheet is received at operation 602, the electronic text document or spreadsheet is sent to the buyer computing device without any formatting changes. In other implementations, the financial institution server computer 106 can make formatting changes to the electronic text document or spreadsheet before forwarding to the buyer computing device. When formatting changes are made, the formatting changes may be consistent with formatting desired or required by the buyer computing device.

When the buyer at the buyer computing device reviews the invoice data received from financial institution server computer 106, the buyer can decide whether to accept the invoice. When the buyer accepts the invoice, at operation 606, an approval for payment of the invoice is received at financial institution server computer 106 from the buyer computing device.

At operation 608, a process is initiated to pay the invoice. For example, in some implementations an electronic confirmation document is sent from financial institution server computer 106 to the buyer computing device. In addition a payment voucher for the supplier is created on financial institution server computer 106. In other implementations, other processes can be implemented to pay the invoice.

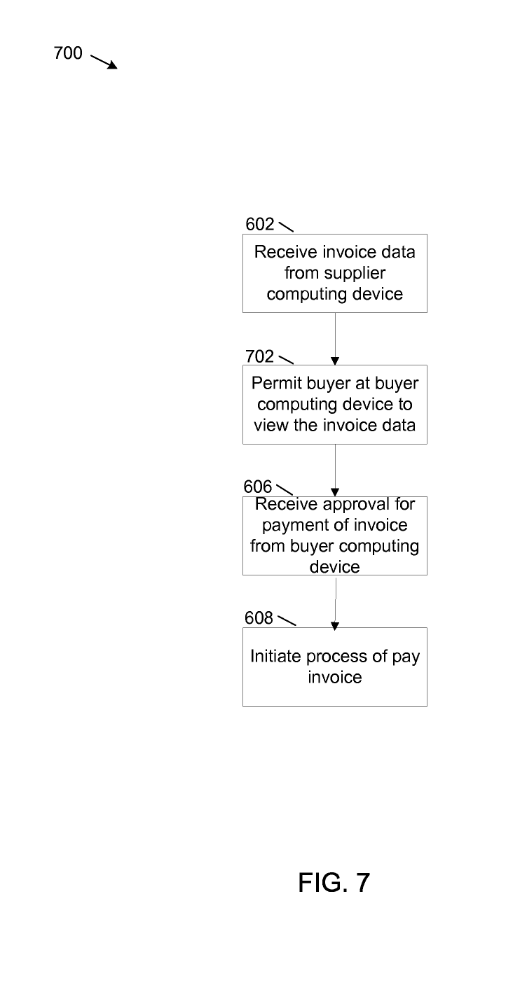

FIG. 7 shows a flowchart of an alternate example method 700 for a process of paying an invoice. For the example method 700, operations 602 and 608 are identical to those operations in method 600. However, for method 700, operations 604 and, regarding sending invoice data to the buyer computing device and approving the invoice are replaced by new operation 702.

At operation 702, the buyer at the buyer computing device is permitted to logon to financial institution server computer 106 and view the invoice data online. If the buyer approves the invoice data, the buyer can approve the invoice online.

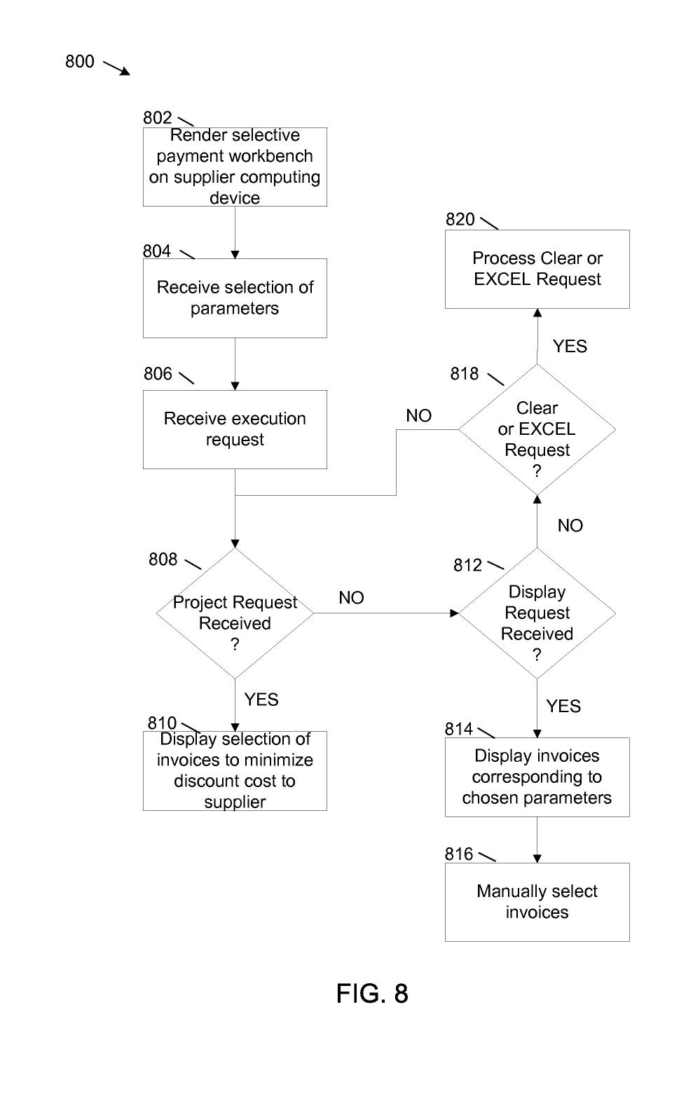

FIG. 8 shows a flowchart of an example method 800 for selecting invoices for early payment from the selective payment workbench. In the example method 800, invoices can either be selected automatically in a way that minimizes a discount cost associated with the early payment or invoices can be selected for early payment manually from the selective payment workbench.

At operation 802, a user interface for the selective payment workbench is rendered on the supplier computing device. For method 800, the user interface is similar to the user interfaces shown in FIGS. 3 and 4. The selective payment workbench is rendered based on user interface data sent from financial institution server computer 106.

At operation 804, a selection of parameters is made on the selective payment workbench and received at financial institution server computer 106. Some example parameters that are received can include a desired dollar amount for early payment, a desired payment date and a selection of a range of invoices to be displayed. As discussed earlier herein with regard to FIGS. 3 and 4, the range of invoices can include 1) all invoices due within a specified number of days, 2) all invoices between a range of dates and 3) all outstanding invoices.

At operation 806, an execution request is received at financial institution server computer 106. For the example user interfaces shown in FIGS. 3 and 4, the execution request can be project, display, clear or EXCEL Export. For other example user interfaces, other execution requests are possible.

At operation 808, a determination is made as to whether a project request is received. As discussed earlier herein, the project request is used when the supplier desires an automatic selection of invoices for early payment that minimizes the discount cost for early payment of invoices.

At operation 808, when a determination is made that a project request is received, at operation 810, a selection of invoices is displayed that is calculated to minimize discount costs associated with early invoice payment based on the parameters selected at operation 804. As discussed earlier herein, an example invoice display for a project request is shown in summary area 322 of FIG. 3.

At operation 808, when a determination is made that a project request is not received, at operation 812, a determination is made as to whether a display request is received.

At operation 812, when a determination is made that a display request is received, at operation 814, a selection of invoices corresponding to the parameters received at operation 804 is displayed. As discussed earlier herein as shown in summary area 322 of FIG. 4, a checkbox is rendered to the left of each line of invoices displayed.

At operation 816, one or more invoices are manually selected. For each invoice selected, a discount cost associated with the invoice is displayed, as shown in summary area 322 of FIG. 4. The supplier can view the discount costs and determine whether the selected invoices are acceptable. If acceptable, the supplier can select a submit button to process the selected invoices for early payment. If not acceptable, the supplier can manually select other combinations of invoices. When the selected invoices are acceptable, the submit button is selected to initiate payment of the selected invoices.

At operation 812, when a determination is made that a display request is not received, at operation 818, a determination is made as to whether a clear or EXCEL request is received. When a clear request is received, the summary area 322 is cleared of displayed invoices and other parameters can be selected per operation 804. When the EXCEL Export request is received, invoice data in summary area 322 is exported to an EXCEL spreadsheet. When a determination is made at operation 818 that neither the clear nor EXCEL Export request is received, control returns to operation 808 to wait for a request to be received.

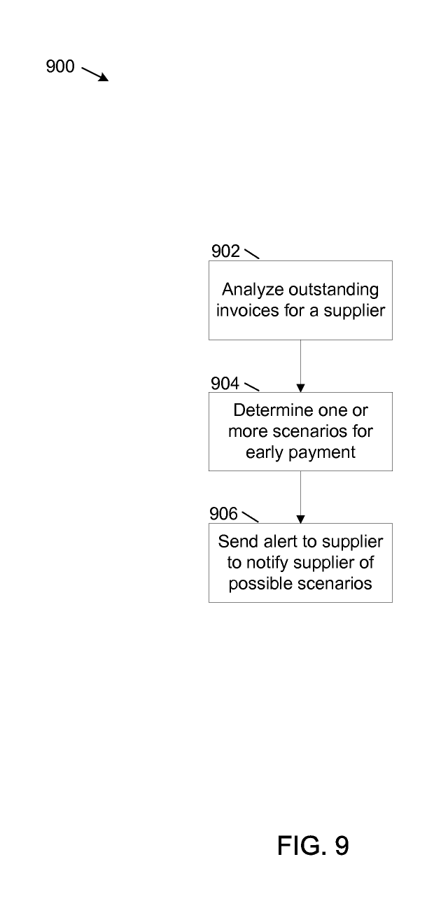

FIG. 9 shows a flowchart of an example method 900 for proactively alerting a supplier of early payment scenarios. As discussed earlier herein, some suppliers do not want to have their invoices discounted and would prefer to wait for the buyer to pay in full. However, if the supplier knew that they could get a certain dollar amount early, for example 1 million dollars within a day or two and they would only need to pay what they may consider to be a reasonable discount, for example $25,000 to get the early payment, some suppliers may reconsider their opposition to not wanting to pay a discount.

At operation 902, a software application on the financial institution server computer 106 analyzes outstanding invoices for a supplier. At operation 904, the software application determines one or more scenarios for early payment. At operation 906, financial institution server computer 106 sends an alert message to the supplier computing device. The alert message notifies the supplier of the one or more scenarios. In addition, in some implementations, the alert message also provides a link to the selective payment workbench. The supplier can logon to the selective payment workbench, view the one or more scenarios and also try out different scenarios. The supplier can also accept one of the scenarios and initiate early payment from the selective payment workbench.

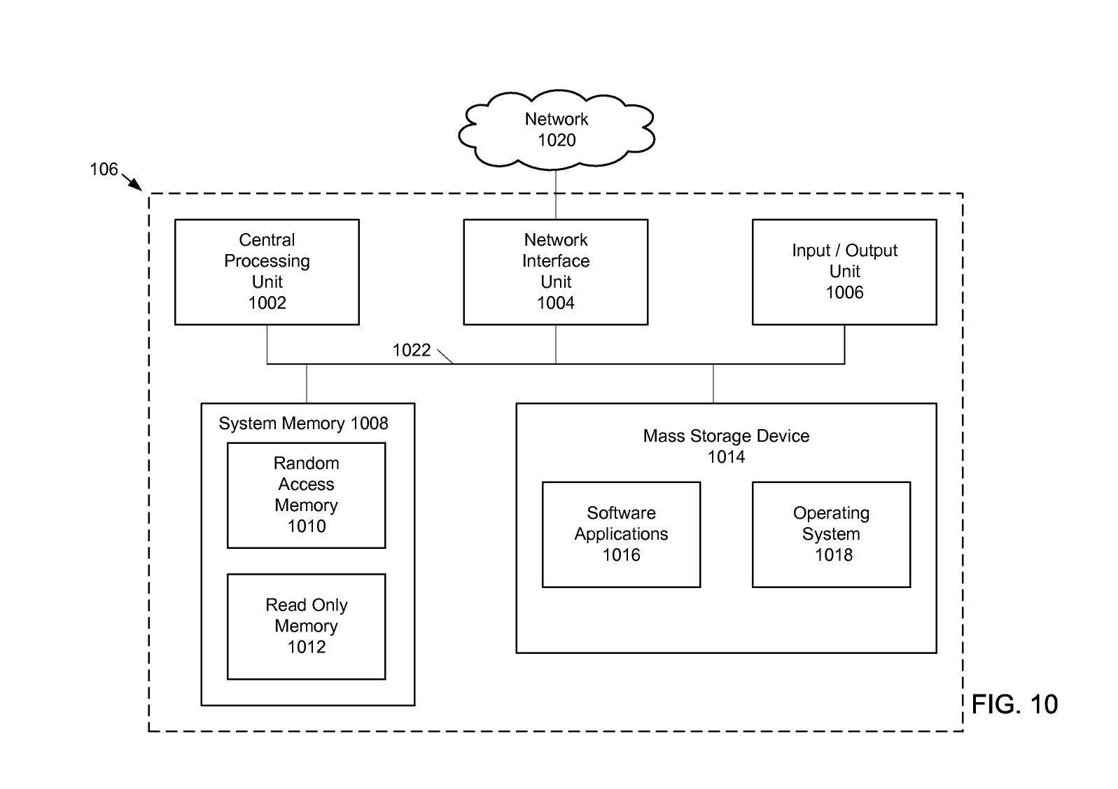

As illustrated in the example of FIG. 10, financial institution server computer 106 includes at least one central processing unit (“CPU”) 1002, a system memory 1008, and a system bus 1022 that couples the system memory 1008 to the CPU 1002. The system memory 1008 includes a random access memory (“RAM”) 1010 and a read-only memory (“ROM”) 1012. A basic input/output system that contains the basic routines that help to transfer information between elements within the financial institution server computer 106, such as during startup, is stored in the ROM 1012. The financial institution server computer 106 further includes a mass storage device 1014. The mass storage device 1014 is able to store software instructions and data. A central processing unit, system memory and mass storage device similar to that in FIG. 10 are also included in financial institution server computer 106.

The mass storage device 1014 is connected to the CPU 1002 through a mass storage controller (not shown) connected to the system bus 1022. The mass storage device 1014 and its associated computer-readable data storage media provide non-volatile, non-transitory storage for the financial institution server computer 106. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the Financial institution server computer 106.

According to various embodiments of the invention, the financial institution server computer 106 may operate in a networked environment using logical connections to remote network devices through the network 1020, such as a wireless network, the Internet, or another type of network. The financial institution server computer 106 may connect to the network 1020 through a network interface unit 1004 connected to the system bus 1022. It should be appreciated that the network interface unit 1004 may also be utilized to connect to other types of networks and remote computing systems. The financial institution server computer 106 also includes an input/output controller 1006 for receiving and processing input from a number of other devices, including a touch user interface display screen, or another type of input device. Similarly, the input/output controller 1006 may provide output to a touch user interface display screen or other type of output device.

As mentioned briefly above, the mass storage device 1014 and the RAM 1010 of the financial institution server computer 106 can store software instructions and data. The software instructions include an operating system 1018 suitable for controlling the operation of the financial institution server computer 106. The mass storage device 1014 and/or the RAM 1010 also store software instructions, that when executed by the CPU 1002, cause the financial institution server computer 106 to provide the functionality of the financial institution server computer 106 discussed in this document. For example, the mass storage device 1014 and/or the RAM 1010 can store software instructions that, when executed by the CPU 1002, cause the financial institution server computer 106 to display received data on the display screen of the financial institution server computer 106.

Although various embodiments are described herein, those of ordinary skill in the art will understand that many modifications may be made thereto within the scope of the present disclosure. Accordingly, it is not intended that the scope of the disclosure in any way be limited by the examples provided.

1. A method implemented on a first electronic computing device for processing invoices, the method comprising:
on the first electronic computing device, receiving, from a second electronic computing device, first invoice data for one or more first invoices, the first invoice data being received from a first supplier and being directed to a first buyer;
receiving an approval for one or more first invoices from a third electronic computing device, the one or more first invoices being based on the first invoice data, the third electronic computing device being associated with the first buyer;
receiving a request from the second electronic computing device for payment for a first dollar amount on a specific date;
rendering a plurality of options for identifying invoices for the payment by the first dollar amount, a selection mechanism being rendered adjacent to each of the plurality of options, the plurality of options being displayed simultaneously on a single user interface screen, the plurality of options including: 1) all invoices due to the first supplier within a specified number of days, 2) all invoices due to the first supplier within a specified date range and 3) all invoices due to the first supplier;
permitting, using the selection mechanism on the single user interface screen, a selection of one of the plurality of options;
receiving the selection of how the invoices are to be identified for the payment of the first dollar amount;
from the invoices included in the selection, automatically determining, by the first electronic computing device, an optimized set of unpaid vouchers for the first supplier, the set of unpaid vouchers being based on the one or more first invoices and any other invoices for which payment is due to the first supplier, a net value of all or part of the set of unpaid vouchers being equal to or greater than the first dollar amount, the net value resulting in a minimum discount cost associated with the unpaid vouchers; and
initiating a payment for all or part of the optimized set of unpaid vouchers for the first supplier.

2. The method of claim 1, further comprising configuring the first invoice data for the one or more first invoices into a format compatible with the third electronic computing device associated with the first buyer.

3. The method of claim 1, further comprising permitting the first invoice data to be viewed from the third electronic computing device.

4. The method of claim 1, wherein the net value comprises a value of all or part of one or more vouchers in the optimized set of unpaid vouchers less a discount cost of the one or more vouchers in the optimized set of unpaid vouchers.

5. The method of claim 4, wherein a discount rate for at least one voucher is inversely proportional from a time period from when an invoice corresponding to one of the unpaid vouchers is due and a date on which the payment is to be made.

6. The method of claim 4, wherein a discount rate for at least one voucher is inversely proportional to a credit rating of an entity to which an invoice corresponding to one of the unpaid vouchers is directed.

7. The method of claim 1, wherein a discount cost for each voucher is inversely proportional to a credit rating of an entity to which an invoice corresponding to the voucher is directed.

8. The method of claim 1, wherein the optimized set of unpaid vouchers corresponds to a set of invoices directed to a plurality of buyers.

9. The method of claim 1, wherein at least one of the unpaid vouchers in the optimized set of unpaid vouchers is for a partial payment of one of the one or more first invoices.

10. The method of claim 1, further comprising sending a notification to the second electronic computing device of a proposal for early payment of invoices from the first supplier.

11. The method of claim 1, further comprising:
receiving from the second electronic computing device second invoice data for one or more second invoices, the second invoice data being received from the first supplier;
sending the second invoices to a fourth electronic computing device, the second invoices being directed to a second buyer; and
receiving an approval for one or more second invoices from the fourth electronic computing device, the one or more second invoices being based on the second invoice data.

12. The method of claim 1, further comprising:
rendering a user interface on the second electronic computing device, the user interface implementing a selective payment workbench for permitting parameters to be selected for payment of invoices; and
receiving a command from the selective payment workbench to automatically determine the optimized set of unpaid invoices.

13. The method of claim 1, further comprising:
rendering a user interface on the second electronic computing device, the user interface implementing a selective payment workbench for permitting parameters to be selected for payment of invoices;
receiving a selection of one or more invoices;
receiving a dollar amount associated with the one or more invoices; and
calculating a discount cost associated with each of the one or more selected invoices.

14. A first electronic computing device for processing invoices, the first electronic device comprising:
a processing unit; and
system memory, the system memory including instructions which, when executed by the processing unit, cause the first electronic computing device to implement:
an invoice data processing module that receives and processes invoice data from a second electronic computing device, the invoice data being comprised of sales data for one or more products that are sold from a first supplier associated with the second electronic computing device to a first buyer associated with a third electronic computing device;
a user interface module that permits selection from a single user interface screen of which invoices to include in a determination of an optimized set of unpaid vouchers for the first supplier, the single user interface screen simultaneously displaying options for the selection of 1) all invoices due to the first supplier within a specified number of days, 2) all invoices due to the first supplier within a specified date range and 3) all invoices due to the first supplier and that permits a display of one of 1) all invoices due to the first supplier within a specified number of days, 2) all invoices due to the first supplier within a specified date range or 3) all invoices due to the first supplier, based on the selection, a selection mechanism being rendered adjacent to each of the options, the selection mechanism allowing a user to select one of the options adjacent to the selection mechanism;
an invoice approval module that permits review by the first buyer of the invoice data and that permits approval of payment for one or more first invoices by the first buyer, the one or more first invoices corresponding to the invoice data;
a payment module that initiates payment of one or more of the one or more first invoices based on the approval of the first buyer; and
a discounting module that determines a minimum discount cost for a set of second invoices initiated from the first supplier to generate a cash payment amount for the first supplier, the set of second invoices including all or part of the one or more first invoices, the cash payment amount to be paid to the first supplier at a specified date, the specified date being earlier than a payment due date for each invoice in the set of second invoices.

15. The first electronic device of claim 14 wherein, the user interface module is configured to render a selective payment workbench for a supplier at the second electronic computing device, the selective payment workbench permitting initiation of a process to automatically determine the minimum discount cost for the set of second invoices based on a selection by the first supplier of one or more parameters.

16. (canceled)

17. The first electronic device of claim 15, wherein the selective payment workbench permits a manual selection of invoices to be paid.

18. The first electronic device of claim 15, wherein a discount cost is calculated based on a discount rate that is inversely proportional to a credit rating of the first buyer and wherein the discount cost is inversely proportional to time frame from the specified date and a date corresponding to when a payment on one of the set of second invoices invoice is due.

19. The first electronic device of claim 15, wherein the selective payment workbench displays invoices directed from the first supplier to a plurality of buyers and wherein the set of invoices comprises invoices from the plurality of buyers.

20. A first electronic device comprising:
a processing unit; and
system memory, the system memory including instructions which, when executed by the processing unit, cause the first electronic device to:
receive, from a second electronic computing device, first invoice data for one or more first invoices, the first invoice data being received from a first supplier and being directed to a first buyer;
receive an approval for one or more first invoices from a third electronic computing device, the one or more first invoices being based on the first invoice data, the third electronic computing device being associated with the first buyer;
receive a request from the second electronic computing device for payment for a first dollar amount on a specific date;
render a plurality of options for identifying invoices for the payment of the first dollar amount, a checkbox being rendered adjacent to each of the plurality of options, the plurality of options being displayed simultaneously on a single user interface screen, the plurality of options including 1) all invoices due to the first supplier within a specified number of days, 2) all invoices due to the first supplier within a specified date range and 3) all invoices due to the first supplier;
permit, the single user interface screen of the first electronic computing device, a selection of of one of the plurality of options, the selection being made by a selection of the checkbox corresponding to the one of the plurality of options;
receive the selection of how the invoices are to be identified for the payment of the first dollar amount;
from the invoices included in the selection, automatically determine the optimized set of unpaid vouchers for the first supplier, the set of unpaid vouchers being based on the one or more first invoices and any other invoices for which payment is due to the first supplier, a net value of all or part of the set of unpaid vouchers being equal to or greater than the first dollar amount, the net value resulting in a minimum discount cost associated with the unpaid vouchers; and
initiate a payment for all or part of the optimized set of unpaid vouchers for the first supplier.
